(19) United States
(12) Patent Application Publication
(10) Pub. No.: US 2015/0120396 A1
(43) Pub. Date: Apr. 30, 2015

(54) Mission Metric System Design

(71) Applicant: Thomas Andrew Heard, McLean, VA (US)

(72) Inventor: Thomas Andrew Heard, McLean, VA (US)

(21) Appl. No.: 14/479,371

(22) Filed: Sep. 7, 2014

Related U.S. Application Data
(60) Provisional application No. 61/896,126, filed on Oct. 28, 2013.

(51) Int. Cl. G06Q 10/06

(52) U.S. Cl. CPC G06Q 10/0637
USPC 705/7.36

(57) ABSTRACT

The Mission Metric System is an original guiding utility for leaders to identify, measure, and act upon their organization's capacity to achieve mission. The Mission Metric System receives survey(s) and a value/mission statement; instantly presents a dashboard of measures; and instantly recommends leadership actions.

### SECTION 1: INTRODUCTION

The Mission Metric System is a research-based instrument to identify, measure, and act upon internal strengths and weaknesses. As a breakthrough tool for all organizations that claim social or shareholder benefit, the Mission Metric System simplifies and standardizes mission measurement to advance industries, governments, for-profit and non-profit corporations, educational institutions, and religious organizations. The output of the Mission Metric System is a dashboard of measured mission effectiveness and a roadmap of customized advice to preserve strengths and transform weaknesses. The Mission Metric System will grow in utility and accuracy as organizations harness its capabilities.

1.1 Purpose

This Mission Metric System Design document describes the system functions, logical processes and data flow. This document also clarifies the system design, facilitates the development of the system, and creates a foundation on which advances may be built. To enable the design, this document specifies system terms, operational concepts, and processes.

1.2 Scope

The Mission Metric System encompasses all organizations, especially those with mission statements or stated values. The Mission Metric System does not measure profit or analyze financial operations; however, the Mission Metric System does complement for-profit corporate operations by measuring the ability to achieve goals, whether for social benefit or for shareholder profit.

### SECTION 2: SYSTEM ARCHITECTURE

2.1 Architectural Design Approach

The Mission Metric System Architecture accomplishes the process flow in FIG. 1. This approach ensures a reinforcing loop of mission content, measurement, controls, and calibration instruments. Using 3 levels of algorithms, the Mission Metric System transforms each inbound data set into outbound products. By continuously expanding the base of data and by adding a calibration cycle step to the approach, the Mission Metric System improves in each cycle of use.

This document describes each process, data element and outbound product. Processes are defined in the Architectural Design section 2.2. The Data Dictionary section describes each data set, data element, and repository. The User Interface section describes the simple concept of entering the Mission Statement and responding to the Self-Assessment e-Form, and then receiving the Mission Dashboard and Action Plan.

2.2 Architecture Design

FIG. 2 depicts the Mission Metric Architecture in a process flow diagram. The depiction employs a SIPOC diagram, which stands for Supplier, Inputs, Process, Outputs, and Consumer. The vertical flow starts from the top center, where Process begins with “Parse Mission Text”, and ends with the final process box at the bottom center, titled “Build Action Plan”.

Each process box in the horizontal center shows inputs on the left with an arrow flowing in; and each process box shows outputs on the right with an arrow flowing out. In many cases, the outputs from one process box are the inputs in a downstream process box. One example is the “E-Questionnaire Responses” output from the 2^{nd} process box entitled “Collect Mission Success Data”. This output is an input to the 4^{th} process box titled “Calculate Mission Success”. This SIPOC format illustrates and clarifies inputs and outputs for each process step.

To the left of each “Inputs” column are Suppliers for each input; and to the right of each “Output” is the consumer for each output. In most cases, Suppliers and Consumers are systems or databases. By standards and automation, this complex system simplifies processing for the Mission Custodian, enables mission trend analysis, and establishes standards. The main themes of FIG. 3 include:
a. the initial inputs are from the Mission Custodian;
b. the Mission Metric System performs all processing;
c. outputs—the mission dashboard and action plan—go to the mission custodian.

The symbols in FIG. 2 include people, systems, databases, algorithms, processes, displays, and documents. Table 1 presents each symbol and its meaning:

TABLE 1
Architectural Symbols

| Symbol | Meaning |
|---|---|
| Mission Custodian | This crown symbol represents the Mission Custodian who is the |
| (Crown Symbol) | operator of the Mission Metric system. The Mission Custodian |
| | provides the mission statement or value statement and one or more |
| | completed questionnaires to the system. The system returns an |
| | assessment (in the form of a dashboard) and an action plan. |
| Mission Metric System | This Mission Metric System symbol represents the data stores, |
| (Oval Shape) | sources of algorithms, inputs, outputs, and designs. This symbol |
| | represents the system as a supplier of inputs and a consumer of |
| | outputs. The system tracks workflow as it transforms inputs into the |
| | mission dashboard and action plan. |
| Mission Statement | The mission statement represents text that codifies an |
| (paper shape) | organization's social obligation. The Mission Metric System uses an |
| | organization's Mission Statement or value statement to apply |
| | algorithms and conduct measurement. |
| Algorithm | The Algorithm symbol is used multiple times to illustrate that inputs |
| (rectangle) | to a process include complex formulas along with data structures. |
| | Each algorithm is labeled according to its function, and is described |
| | in detail later in this document. |
| Process | Each process symbol represents a workflow phase in the Mission |
| (Square) | Metric systemEach process transforms inputs into outputs. |
| | Processes reside in the center column of the Mission Metric |
| | Architecture diagram. This symbol represents the system's core |
| | functions. Process workflow begins at the top center process and |
| | flows downward as processing advances. |
| Database Content | This database symbol uses multiple labels although all database |
| (Tube Shape) | functions and storage is in the single Mission Metric database. The |
| | database stores all data inputs and outputs, algorithms, reports, and |
| | repositories. Processes extract data from the Mission Metric |
| | database and store results in the same database. |
| Expertise | This symbol is used only once and represents input from the Mission |
| (Manual Input Symbol) | Custodian, whose expertise is encoded through completing the E- |
| | Questionnaire. This expertise is a fundamental dependency for the |
| | system. |
| E-Questionaire | The E-Questionnaire (also called a survey) symbol is used only once, |
| (rectangle within | and captures expertise from the Mission Custodian, or as many |
| rectangle) | participants as the Mission Custodian selects. The E-Questionnaire |
| | is described in detail later with its multiple dimensions of mission. |
| Input/Output Symbol | The first system output, the Mission Dashboard, displays mission |
| (Parallelogram) | readiness. The second system output, Mission Action Plan, is a |
| | prescriptive list of actions, according to research, that the Mission |
| | Custodian should consider to improve and sustain mission |
| | performance. |

### SECTION 3: DATA DICTIONARY

Table 2 lists each research-based data element (listed as Mission Element) that is used to measuring mission. Each element has a unique name. The descriptions summarize the impacts on achieving mission. Mission Elements are used throughout the Mission Metric System.

TABLE 2
Mission Elements

| Element | Description |
|---|---|
| Aims | The extent to which the mission preserves functional area individual aims or |
| | goals (avoids the pitfall) |
| Autonomy | The extent to which the mission preserves functional area autonomy over |
| | resources and productivity (avoids the pitfall) |
| Awareness | The extent to which mission is known |
| Cohesiveness | The extent to which individuals in all functions identify themselves with mission |
| Collaboration | The extent to which the mission enables functional areas to accomplish their |
| | goals. |
| Commitment | The extent to which each functional areas allocate resources to mission |
| Commonality | The extent to which dissimilar functions support each other for the common |
| | mission |
| Competence | The extent to which the organization is capable of fulfilling the mission |
| Confidence | The measure of positive outlook that the organization is accomplishing mission |
| Connection | The extent to which functional goals are connected to the organizational mission |
| Construction | The extent to which individuals interact constructively to accomplish mission |
| Control | The extent to which the mission preserves functional area control and authority |
| | (avoids the pitfall) |
| Convergence | The extent to which functional areas converge to accomplish mission rather than |
| | contend for resources, control and glory |
| e-Form | Self-assessment data collection instrument filled by Mission Custodian |
| Environment | The extent to which mission-related activities enable adapting to environmental |
| | change |
| e-Tools | The extent to which area functions are equipped with online tools that enable |
| | mission through structured communications and knowledge transfer |
| Flexibility | The extent to which the mission preserves functional area flexibility (avoids the |
| | pitfall) |
| Glory | The extent to which the mission preserves functional area glory, or attributed |
| | success (avoids the pitfall) |
| Influence | The extent to which functional areas can influence mission operations |
| Integration | The extent to which mission-related structures, including processes and |
| | technologies, are open for use, connection, and duplication across the |
| | organization. |
| Mission | Written obligation of great magnitude. |
| Network | The extent to which mission-related activities encourage functional areas to |
| | identify and leverage other parts of the organization with similar business |
| | processes or supply chains |
| Planning | The extent to which functional areas can participate in mission planning |
| Pool | The extent to which the mission expands each functional area's pool of expertise |
| Power | The extent to which functional areas gain power by participating in mission |
| Preparation | The quality of mission-related events - in terms of planning, organizing and |
| | implementing. Mission-related events may include staff meetings, all-hands |
| | meetings, milestone celebrations, and others. |
| Realism | The extent to which the mission is feasible |
| Relationships | The extent to which individuals and mission partners have beneficial interactions |
| Relevance | The extent to which everyday operations are related to mission |
| Reports | The extent to which mission-related reports are useful |
| Resources | The extent to which all functions are properly equipped to accomplish mission |
| Reward | The extent to which individuals share the rewards of mission progress |
| Risk | The extent to which all functions share risks and resources to accomplish mission |
| Rules | Instructions and policies that enforce mission as the foremost organizational |
| | priority |
| Solving | The extent to which mission-related activities help to solve difficult problems |
| Teamwork | The extent to which mission-related work is properly assigned, performed and |
| | managed |
| Transparency | The extent to which individuals communicate openly about mission |
| Value | The extent to which mission-related events add value |
| Vision | The extent to which area functions and leadership have a shared vision and joint |
| | goals |
| Willingness | The extent to which functional areas work together willingly |

### SECTION 4: DATA DESIGN

4.1 Persistent/Static Data

Because inputs to the Mission Metric System impact future measures, the system has no persistent or static data. Static instruments (subject to calibration) include the Self-Assessment e-Questionnaire, algorithms, and output templates.

4.2 Transient/Dynamic Data

Transient/Dynamic Data includes elements from the Data Dictionary in Table 2. Each element is a database field, stratified according to Mission Attributes. FIG. 3 illustrates Mission Attributes as database tables, and each element in Table 2 is assigned to a data element table in the Mission Metric System.

### SECTION 5: USER INTERFACE CONCEPT

The user interface will be designed specifically to decrease complexity and burden from the Mission Custodian. The Mission Custodian uploads the Mission Statement and then responds to the e-Questionnaire. FIG. 4 illustrates that the Mission Metric System performs all the complex calculations necessary to build and deliver the user's mission dashboard and action plan.

### SECTION 6: E-QUESTIONNAIRE

Combined with the Mission Statement, the Mission Metric e-Questionnaire is the external input basis to measure mission performance. The first part of the e-questionnaire will request profile information, such as company size and industry. Table 4 lists each question, its corresponding data element (described in the data dictionary), and its corresponding database table.

The actual e-Questionnaire will employ a 5-level Likert scale for each question. Each entry makes a statement, and the Mission Manager will indicate his level of agreement as follows:

1 Strongly Disagree

2 Disagree

3 Undecided or Not Applicable

4 Agree

5 Strongly Agree

TABLE 4
Mission Metric e-Questionnaire

| | | Corresponding | |
|---|---|---|---|
| | Question | Data Element | Table |
| 1 | Our mission does not disrupt my functional | Aims | Avoiding |
| | area's goals | | Pitfalls |
| 2 | Our mission does not disrupt my functional | Autonomy | Avoiding |
| | area's resources or productivity | | Pitfalls |
| 3 | Our mission is consistently known by all | Awareness | Mission |
| | members | | |
| 4 | Our mission pulls members together to form | Cohesiveness | Trust |
| | a single organization | | |
| 5 | Having a common mission enables my | Collaboration | Goal |
| | functional area to perform better than it | | |
| | could alone | | |
| 6 | All of our functional areas are committed to | Commitment | Trust |
| | our common mission | | |
| 7 | Other parts of the organization demonstrate | Commonality | Trust |
| | interest in my functional area | | |
| 8 | Other members of my organization have | Competence | Trust |
| | expertise, and I can depend on them to help. | | |
| 9 | Our common mission will be successful | Confidence | Trust |
| 10 | All of our functional areas have a win-win | Connection | Participation |
| | arrangement | | |
| 11 | All of our functional areas interact | Construction | Trust |
| | constructively | | |
| 12 | Our common mission does not disrupt my | Control | Avoiding |
| | functional area's control | | Pitfalls |
| 13 | Functional areas have more points of | Convergence | Participation |
| | convergence than of contention | | |
| 14 | Functional areas have a common online tool | e-Tools | Technology |
| | that enables structured communication and | | |
| | knowledge transfer | | |
| 15 | Having a common mission equips us to | Environment | Facilitation |
| | respond to changes | | |
| 16 | Our common mission does not disrupt my | Flexibility | Avoiding |
| | functional area's flexibility | | Pitfalls |
| 17 | Our common mission does not disrupt my | Glory | Avoiding |
| | functional area's glory | | Pitfalls |
| 18 | My functional area can influence activities to | Influence | Participation |
| | achieve our common mission | | |
| 19 | My functional area is open for other | Integration | Participation |
| | functional areas to learn and contribute | | |
| 20 | Mission activities have helped us to identify | Network | Facilitation |
| | other functional areas that have similar | | |
| | business interests | | |
| 21 | My functional area participates in planning | Planning | Participation |
| | our organization's strategy | | |
| 22 | Mission activities expand my functional | Pool | Goal |
| | area's pool of expertise | | |
| 23 | Our common mission adds power to my | Power | Participation |
| | functional area | | |
| 24 | Mission achievement activities, such as all- | Preparation | Facilitation |
| | hands meetings and awards events, are well | | |
| | prepared | | |
| 25 | My organization's Mission Statement has | Realism | Facilitation |
| | realistic goals and timelines | | |
| 26 | My personal relationship with the | Relationships | Participation |
| | organization's leadership and other members | | |
| | has been beneficial to the organization | | |
| 27 | Organization-wide meetings help my | Relevance | Trust |
| | functional area to exchange useful | | |
| | knowledge | | |
| 28 | Organization-wide reports are useful | Reports | Facilitation |
| 29 | My organization has sufficient resources to | Resources | Facilitation |
| | ensure a successful mission | | |
| 30 | Mission achievement activities, such as all- | Reward | Trust |
| | hands meetings and awards events, enable | | |
| | rewarding interactions with other functional | | |
| | areas | | |
| 31 | All functional areas share risks and resources | Risk | Participation |
| 32 | My organization has clear ground rules for | Rules | Facilitation |
| | interactions among functional areas and | | |
| | other stakeholders | | |
| 33 | My organization facilitates problem solving | Solving | Facilitation |
| | where the problem is not well defined | | |
| 34 | There is a clear distinction between what is | Teamwork | Goal |
| | the responsibility of my functional area and | | |
| | other functional areas | | |
| 35 | My organization engages in an inquiring style | Transparency | Trust |
| | of communications, free to share each | | |
| | other's thoughts and ideas | | |
| 36 | Organization-wide meetings add value | Value | Facilitation |
| 37 | My organization's leadership, functional | Vision | Goal |
| | areas, and members have a shared vision and | | |
| | joint goals | | |
| 38 | My organization has a structure that | Willingness | Trust |
| | encourages members to work together | | |
| | willingly | | |

### SECTION 7: ALGORITHMS

7.1 Mission Statement Parsing

The purpose of parsing the Mission Statement is to count occurrences of mission elements and then use the counts to assign a weight to each mission element (in the Mission Element Weighting algorithm). In the Mission Statement algorithm, the existence of a mission element (or a synonym thereof) within the text of the Mission Statement increases the weight of that mission element. The following algorithm employs pseudo-code and uses MS SQL textual database commands. The symbols /* and */ delimit comments for the reader. The results of this algorithm are not displayed directly to the Mission Custodian, but instead are used by downstream algorithms.

FREETEXT (with THESAURASUS argument)
CONTAINS (with NEAR argument)
For each Mission Metric Data Element Table;
/* includes Mission, Goal, Participation, Facilitation, Avoiding Pitfalls,
Trust, and Technology */
For each data element within each table;

Count the occurrences of data element (and its synonyms) in the
Mission Statement;
Add 1 to the count if there is an associated emphasis word before the
data element;
/* such as the word “very”, “exceptionally”, “highly”, and so
forth... */
Add 1 to the count if there is an “avoid” (or synonym) NEAR an
Avoid Pitfalls element;
Store element count in Mission Metric database;

Return count for each element (Element_Count);

7.2 Mission Element Weighting

The Mission Weighting Algorithm accepts element counts from the Mission Statement Parsing Algorithm, and calculates weights for each Data Element Table. These weights are used in the Mission Success Algorithm to ensure proper emphasis according to the Mission Statement. The results of this algorithm are not displayed directly to the Mission Custodian, but instead are used by downstream algorithms.

Mission Metric Data Elements are associated with actions to achieve mission, and are not used to measure Mission Statement quality. Weighting is necessary to account for strategy that is sometimes contained within the Mission Statement. Without this feature, all tables would be equivalent in weight regardless of strategy directives within the Mission Statement.

The following pseudo-code represents the Mission Element Weighting algorithm:

```
For each Mission Metric Data Element Table;
  Sum all data Element_Count(s) within each table;
  Store each Table Sum in Mission Metric database;
  Return sum for each table (Table_Sum); /* to be used in the Mission
  Success algorithm */
```

7.3 Mission Success

The purpose of the Mission Success algorithm is to calculate the measures in the Mission Dashboard. The dashboard contains summary analysis from Industry and Global Position Repositories, the e-Questionnaire responses, and the criteria weights. The result is a blend of self-assessment and comparative assessment. The results of this algorithm are not displayed directly to the Mission Custodian, but instead are used by downstream algorithms.

For each Mission Metric Data Element Table;
Data Element Table Multiple (Table_Multiple)=1+(Table_Sum/10) /* for example:=1.3 */
Data Element Table Value (Table_Value)=TotalTable_Questionnaire_Scores/Total_Possible_Table_Questionnaire_Scores /* returns percentage as score */

Returns Table_Multiple /* to be used to calculate dashboard overall mission score */

Returns (Table_Value) /* to be used as dashboard mission attribute score */

7.4 Action Correlation

The Action Correlation algorithm recommends actions from the Action Repository to improve scores on the Dashboard. Using the Pareto statistical method, actions are correlated to the top 80% of data elements that are reducing the score in each table. Correlated actions are fed to the Action Plan (see Action Plan Template section).

Table 5 is an example of applying Pareto analysis to the Participation Table. Ranked inversely to their scores (least to greatest), Mission Element scores are accumulated to calculate the percent of the total gap. According to the Pareto statistical method, the greatest attention should be applied to the top 80% that cause the gap.

TABLE 5
Cumulative Gap Example (Participation Table)

| Participation Table | Score | Cumulative Gap |
|---|---|---|
| Risk | 32 | 29% |
| Relationship | 38 | 56% |
| Planning | 45 | 80% |
| Convergence | 84 | 87% |
| Conection | 90 | 91% |
| Power | 92 | 95% |
| Integration | 93 | 98% |
| Influence | 95 | 100% |

The Table 5 example indicates that the first 3 Mission Elements; Risk, Relationship, and Planning; cause 80% of the gap. FIG. 5 illustrates the cumulative example in a different format, demonstrating how Risk, Relationship and Planning scores cause 80% of the gap. This information is used for the Mission Dashboard and the Action Plan.

In this example, Risk, Relationship, and Planning actions would be correlated from the Mission Action Repository, resulting in actions fed to the Action Plan. Table 6 lists actions that may be included in the Action Plan. These actions are designed to improve the overall score of the host table. In the Table 6 example, the host table is Participation.

TABLE 6
Correlated Statements Fed to the Action Plan (example)

| Deficient | | |
|---|---|---|
| Mission Area | Action Statements fed to the Action Plan | |
| Risk | a. | Add commonality to supply chains |
| | b. | Identify complementary resources among |
| | | dissimilar organizations (for sharing |
| | | opportunity) |
| Relationship | a. | Choose and develop collaborative partners |
| | b. | Maintain personal relationships |
| | c. | Keep open and frequent communication |
| Planning | a. | Include multiple departments in planning |
| | | and implementation |
| | b. | Define levels of interaction in the |
| | | planning process, and increase or |
| | | decrease accordingly |

7.5 Industry Position Assessment

Each Mission Custodian enters his/her industry in the profile. Results of the Self-Assessment are added to the Industry Position Assessment. Each Industry Position Assessment is refreshed at the beginning of each calendar year, and is calculated only after the results are statistically relevant (with 30 or more Self-Assessments from different organizations within the industry). FIG. 6 illustrates the process to summarize statistically relevant Industry Position averages for each calendar year.

7.6 Global Position Assessment

Results of all Self-Assessments are added to the Global Position Assessment, regardless of industry. Each Global Position Assessment is refreshed at the beginning of each calendar year, and is calculated only after the results are statistically relevant (with 30 or more Self-Assessments from different organizations within any industry). FIG. 7 illustrates the process to summarize statistically relevant Global Position averages for each calendar year.

### SECTION 8: REPOSITORIES

8.1 Industry Position Repository

The Industry Position Repository holds non-identifying results for all organizations. Sorted by only a unique organizational identifier and industry name, the repository becomes the source of data for industry average scores for each table in the dashboard. Stratified from a list found on Jigsaw.com, the following industries are the initial selection for the organizational profile:

| | |
|---|---|
| 1. | Agriculture and Mining |
| 2. | Business Services |
| 3. | Computer and Electronics |
| 4. | Consumer Services |
| 5. | Education |
| 6. | Energy and Utilities |
| 7. | Financial Services |
| 8. | Government |
| 9. | Health, Pharmaceuticals, and Biotech |
| 10. | Manufacturing |
| 11. | Media and Entertainment |
| 12. | Non-profit |
| 13. | Other |
| 14. | Real Estate and Construction |
| 15. | Religious Institution |
| 16. | Retail |
| 17. | Software and Internet |
| 18. | Telecommunications |
| 19. | Transportation and Storage |
| 20. | Travel Recreation and Leisure |
| 21. | Wholesale and Distribution |

8.2 Global Position Repository

The Global Position Repository is the union of all industries, and contains results from all responding organizations with their identifying information removed. This repository is used to calculate averages of all organizations regardless of industry. Mission Custodians use this information as a guide for comparison of their organization's mission-achieving activities with the rest of the world.

8.3 Mission Action Repository

The Mission Action Repository stores research-based actions that may increase scores within a table (as demonstrated in the example in the Action Correlation section). This repository serves to feed the Action Correlation Algorithm, where each Data Element is associated with an action if analysis shows that its score requires organizational improvement. Table 7 provides an example of the content of the Mission Action Repository at startup. This repository will be continuously refined and updated as the Mission Metric System is used.

TABLE 7
Research-Based Mission Action Repository Initial Content

| | Data | |
|---|---|---|
| Table | Elements | Actions |
| Technology | e-Tools | Select a mission-enhancing collaborative |
| | | online tool |
| | | Integrate advanced technologies to support |
| | | mission |
| | | In selecting technology, consider impacts to: |
| | | a. Organizational structures |
| | | b. Social interactions across functional areas |
| | | c. Existing or planned technical environments |
| | | Adopt mission visualization tools |

### SECTION 9: THE MISSION DASHBOARD

Table 8 provides the content of the Mission Metric Dashboard. This dashboard provides self-assessment data according to the database tables, and then provides side-by-side comparisons with other organizations in the same industry. The dashboard then provides the global perspective. To illustrate trends, the dashboard contains the previous 2 years of summary data

TABLE 8
Draft Mission Dashboard Content Example

| | | Self- | Your | The |
|---|---|---|---|---|
| Mission Attribute | | Assessment | Industry | World |
| 1. | Awareness: the extent to which Mission | 60 | 71 | 65 |
| | is known by all members | | | |
| 2. | Trust: the extent to which functional | 85 | 68 | 53 |
| | areas believe that leadership and other | | | |
| | functional areas are willing and capable | | | |
| | to represent their interests | | | |
| 3. | Goal: the extent to which mission- | 70 | 72 | 74 |
| | achieving activities enhance processes in | | | |
| | functional areas | | | |
| 4. | Participation: the extent to which | 45 | 78 | 80 |
| | leadership and functional areas are | | | |
| | involved in each other's success | | | |
| 5. | Facilitation: the extent to which | 52 | 50 | 60 |
| | leadership and functional areas promote | | | |
| | each other's processes in their own | | | |
| | activities | | | |
| 6. | Technology: the extent to which | 90 | 82 | 85 |
| | technology is used to facilitate mission | | | |
| 7. | Avoiding Pitfalls: the extent to which | 60 | 75 | 75 |
| | mission activities remain compatible | | | |
| | with functional area activities | | | |

| | | | |
|---|---|---|---|
| 2013 Overall Mission | 66 | 71 | 70 |
| 2012 Overall Mission | 65 | 68 | 70 |
| 2011 Overall Mission | 72 | 63 | 69 |

### SECTION 10: THE ACTION PLAN

TABLE 9
Action Plan Example
Organization ID: 20139999
Industry: Financial Services

1. Share Risk and Resources
Functional areas in your organization are reluctant to participate because
mission risks and resources are not shared properly. Shared risk and
resources are your highest priority, accounting for 29% of the gaps
identified in this analysis.
Action
While achieving mission, ensure and communicate that functional areas
retain:
a. Sufficient resources and continued productivity
b. The culture of the functional area
c. Individual goals of the functional area
2. Improve Organizational Relationships
Functional areas in your organization are reluctant to participate because
their organizational relationships have not been beneficial. Relationships
are a very important priority, accounting for 27% of the gaps identified
in this analysis.
Action
a. Increase commonality of supply chains across functional areas
b. Identify and share complementary resources across functional areas
3. Expand Participation in Planning Mission
Functional areas in your organization are reluctant to participate because
their functional areas are not participating in planning mission strategy.
Participation is a very important priority, accounting for 24% of the gaps
identified in this analysis.
Action
a. Include multiple functional areas in planning and implementing mission

### SECTION 11: CLAIM

This invention comprises the original integration of decomposed elements of mission used to create the survey instrument; the original methods to transform survey responses into organizational measures of capacity to achieve mission; the original integration of mission or value statement algorithms to weight the importance of mission elements; the original application of the resulting measures to inform the mission custodian of mission performance; and the original linking of operational actions to performance measures.

From the user perspective, FIG. 4 illustrates the simple use of the Mission Metric System that consumes the mission statement and survey response, and delivers a dashboard with advice.

From the system perspective, FIG. 2 illustrates the complex operations performed by the Mission Metric System to deliver immediate and actionable results.

### SECTION 12: BRIEF DESCRIPTION OF FIGURES

FIG. 1, titled “Mission Metric Data Flow Diagram”, depicts the Mission Metric System as a data transformation engine. Mission Metric receives data from the user, adds multiple repositories of research data, and feeds this raw data to several algorithms that transform the raw data into system products. The system products are a Mission Dashboard and an Action Plan, each of which informs the user of the organizational strengths and weaknesses, and then provides advice to the user. The feedback loop, called the calibration cycle, ensures that the system continuously improves.

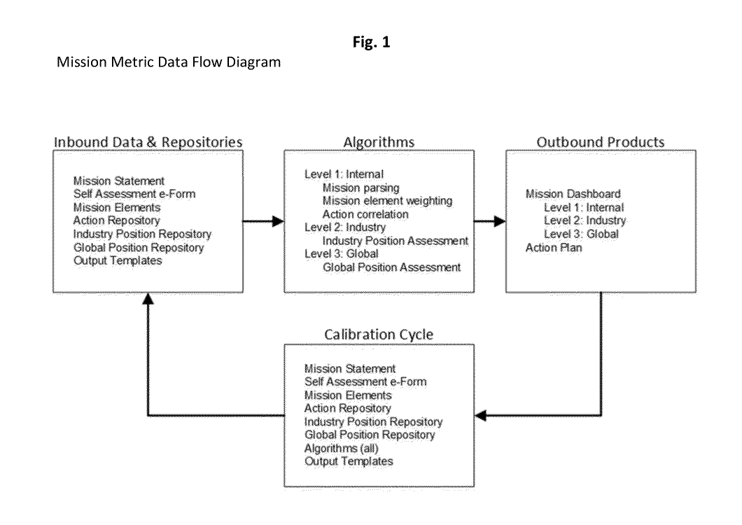

FIG. 2, titled “Mission Metric System Architecture”, illustrates the Mission Metric System as a process. Using the SIPOC technique (supplier, input, process, output, consumer), the process demonstrates the full scope of Mission Metric operations. FIG. 2 shows the behind-the-scenes activities that the user never sees.

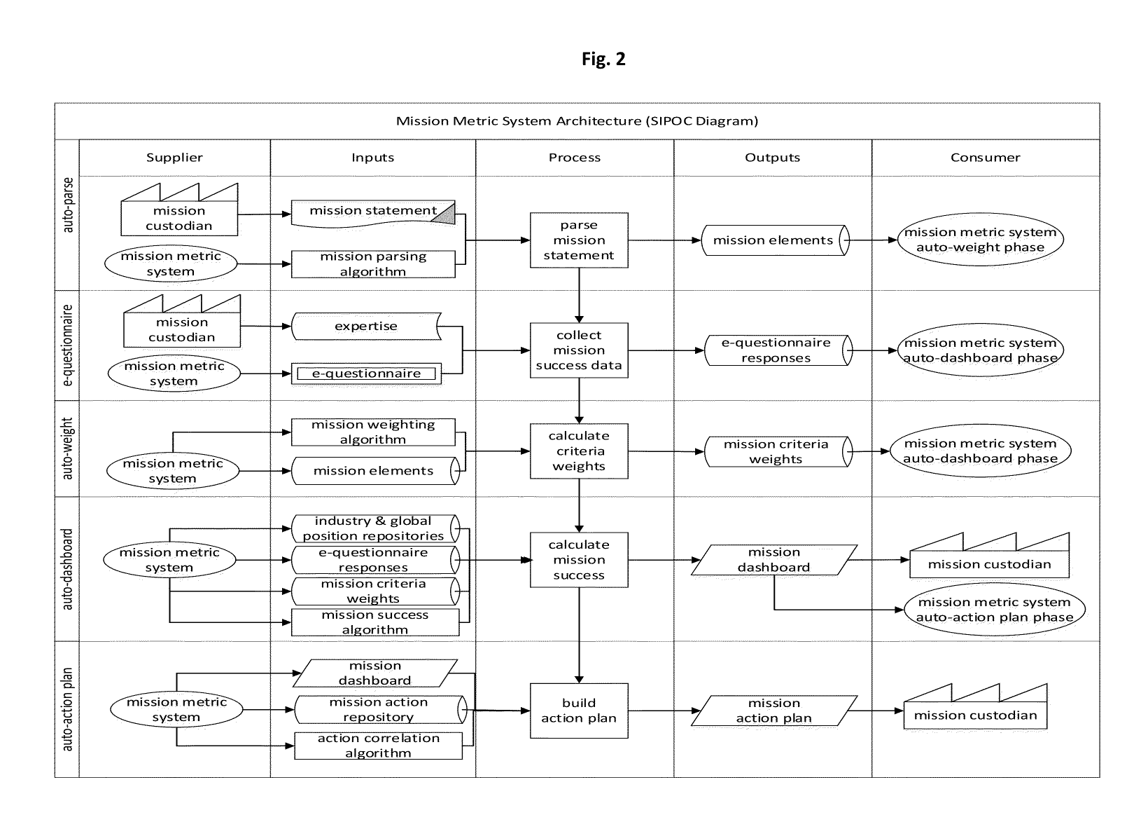

FIG. 3, titled “Data Element Tables”, shows the Mission Metric database tables and their elements. The database holds survey responses in each element category. The database also uses algorithms to produce the Mission Dashboard and the Action Plan.

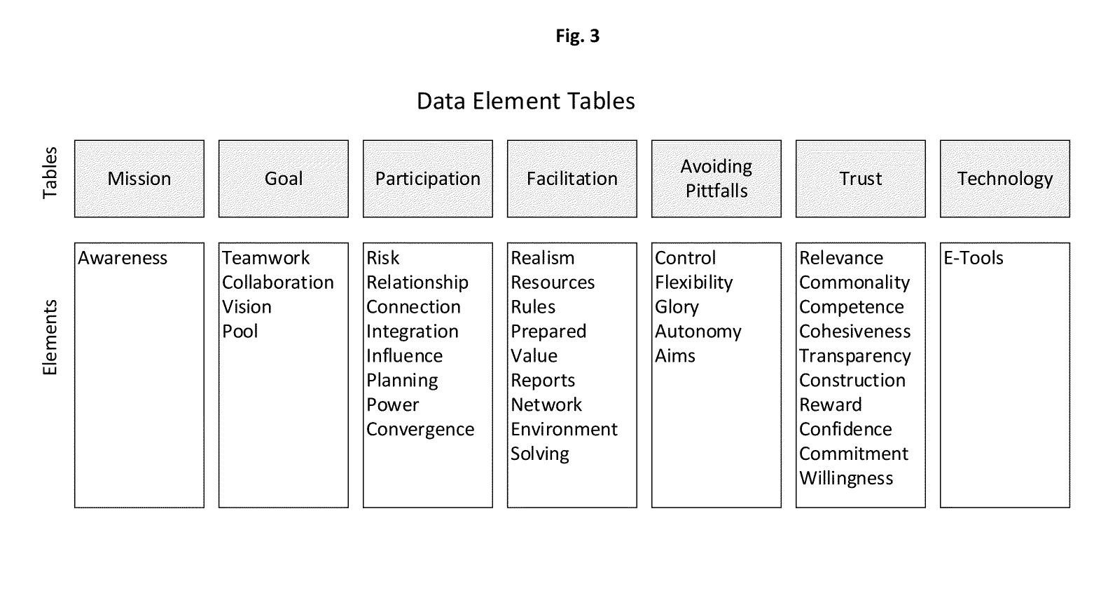

FIG. 4, titled “Mission Metric User Perspective”, shows the Mission Metric System in a simple user perspective. The system receives the survey response and the Mission (or Values) Statement, and produces the Mission Dashboard and the Action Plan.

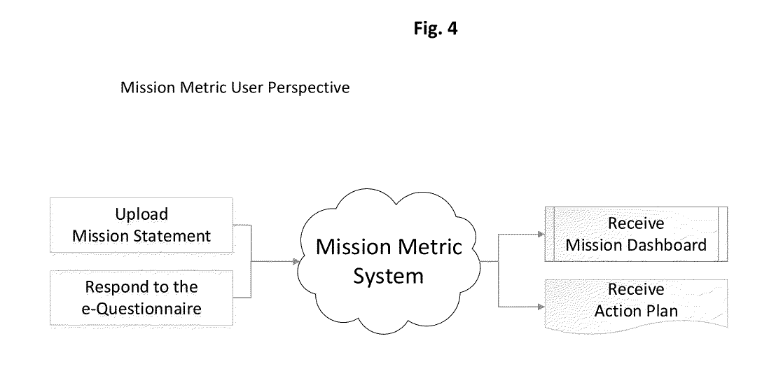

FIG. 5, titled “Pareto Analysis Example”, illustrates the potential output of the Mission Metric algorithm. This output is used to create the Action Plan by focusing on the top 20% of needed improvement. Combined with the Data Element Tables in FIG. 3, FIG. 5 applies the Pareto technique to the original Mission Metric measures, to produce precise advice in the Action Plan.

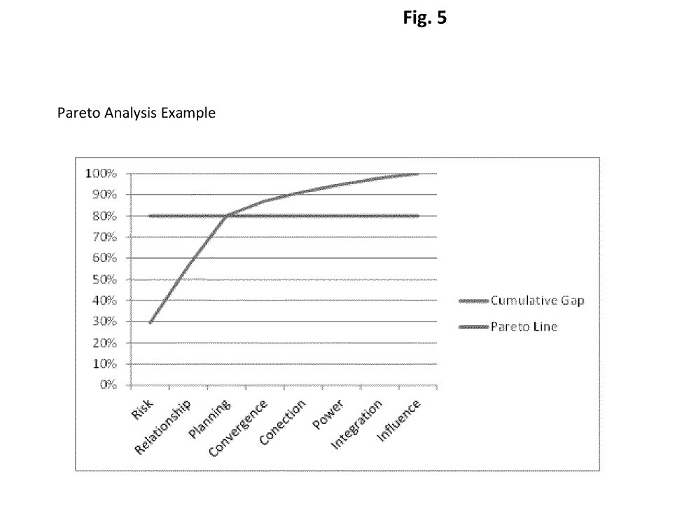

FIG. 6, titled “Industry Position Assessment Algorithm”, illustrates how the Mission Dashboard industry position is derived. The system accumulates industry position data until 30 organizations have responded within that industry, and then presents each organization's position within its industry.

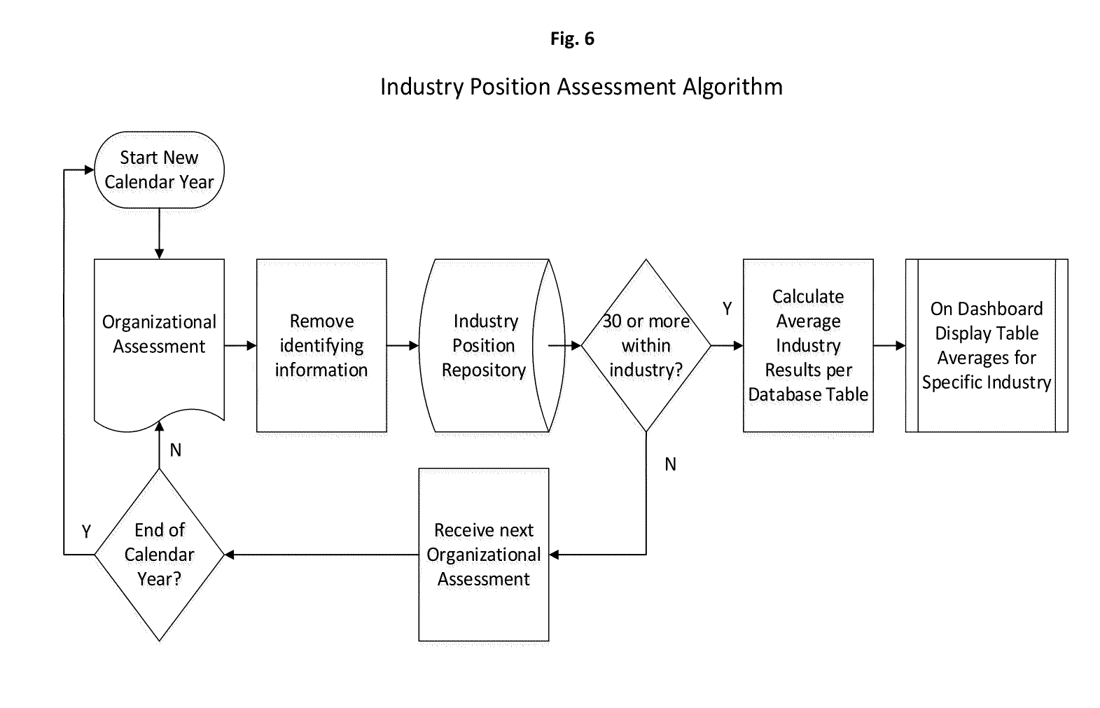

FIG. 7, titled “Global Position Assessment Process”, illustrates how the Mission Dashboard global position is derived. Similar to FIG. 6, the Global Position Assessment Process accumulates a total of 30 responses (regardless of industry), and then presents each organization's position among all industries.

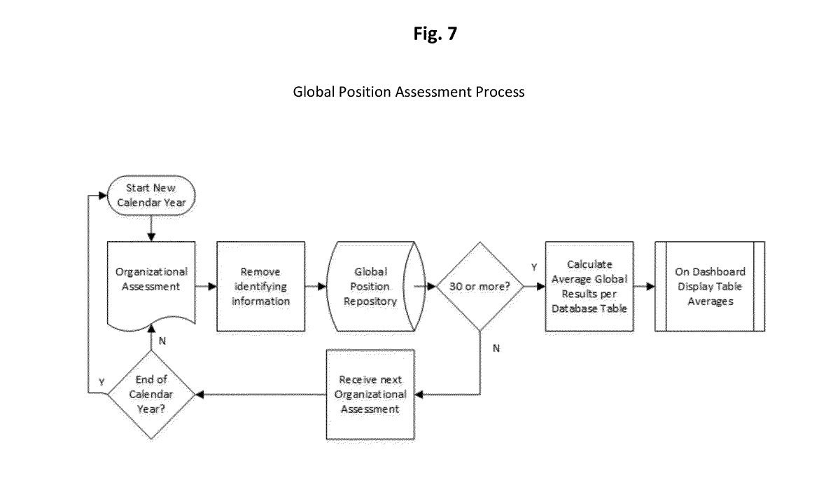

1. This invention comprises the original integration of decomposed elements of mission used to create the survey instrument; the original methods to transform survey responses into organizational measures of capacity to achieve mission; the original integration of mission or value statement algorithms to weight the importance of mission elements; the application of the resulting measures to inform the mission custodian of mission performance; and the linking of operational actions to performance measures.
From the user perspective, Drawing 4 illustrates the simple use of the Mission Metric System that consumes the mission statement and survey response, and delivers a dashboard with advice.
From the system perspective, Drawing 2 illustrates the complex operations performed by the Mission Metric System to deliver immediate and actionable results.
